(19) United States
(12) Patent Application Publication
(10) Pub. No.: US 2026/0074335 A1
(43) Pub. Date: Mar. 12, 2026

(54) SECONDARY BATTERY

(71) Applicant: SAMSUNG SDI CO., LTD., Yongin-si (KR)

(72) Inventors: Bum Rae KIM, Yongin-si (KR); Da Hyun KIM, Yongin-si (KR)

(21) Appl. No.: 19/188,845

(22) Filed: Apr. 24, 2025

(30) Foreign Application Priority Data
Sep. 6, 2024 (KR) 10-2024-0121409

(51) Int. Cl. H01M 50/202; H01M 50/105; H01M 50/119; H01M 50/136; H01M 50/143

(52) U.S. Cl. CPC H01M 50/202; H01M 50/105; H01M 50/119; H01M 50/136; H01M 50/143

(57) ABSTRACT

A secondary battery comprises an electrode assembly including a first electrode plate, a second electrode plate, and a separator. A case is provided for accommodating the electrode assembly. A deformation prevention member is provided in contact with an outer surface of the case and configured to prevent deformation of the case.

### CROSS-REFERENCE TO RELATED APPLICATION

This application claims priority to and the benefit of Korean Patent Application No. 10-2024-0121409 filed on Sep. 6, 2024, in the Korean Intellectual Property Office, the entire disclosure of which is incorporated herein by reference.

### BACKGROUND

### 1. Field

The present disclosure relates to a secondary battery.

### 2. Description of the Related Art

Unlike a primary battery that cannot be recharged, a secondary battery is a battery that can be recharged and discharged. A low-capacity secondary battery may be used for portable small-sized electronic devices, such as smartphones, feature phones, notebook computers, digital cameras, and camcorders, and a high-capacity secondary battery may be used as a power source for driving a motor and a power storage battery in hybrid vehicles or electric vehicles. The secondary battery may include an electrode assembly having a positive electrode and a negative electrode, a case accommodating the electrode assembly, an electrode terminal connected to the electrode assembly, and the like.

The above-described information disclosed in the technology that serves as the background of the present disclosure is only for improving understanding of the background of the present disclosure and thus may include information that does not constitute the related art.

### SUMMARY

The present disclosure provides a secondary battery capable of maintaining a constant distance between internal components.

In addition, the present disclosure provides a secondary battery capable of effectively preventing deformation of a case.

These and other aspects and features of the present disclosure will be described in or will be apparent from the following description of embodiments of the present disclosure.

An exemplary secondary battery according to an embodiment of the present disclosure may include an electrode assembly including a first electrode plate, a second electrode plate, and a separator; a case for accommodating the electrode assembly; and a deformation prevention unit in contact with an outer surface of the case and configured to prevent deformation of the case.

In some examples, the electrode assembly is in the form of a jelly roll or a stack.

In some examples, the case may is formed from a soft film.

In some examples, the case may is formed from an aluminum laminate sheet.

In some examples, the deformation prevention unit may include: a base part that contacts the outer surface of the case; and a protrusion support part that is provided along an outer rim of the base part and supporting an outer rim of the case.

In some examples, the base part may be formed from a film having insulating and flame-retardant properties.

In some examples, the film may include at least one of polyimide (PI), polyether ether ketone (PEEK), and polytetrafluoroethylene (PTFE).

In some examples, the base part may include at least one of mica, a polymer tape, and a pressure-sensitive tape.

In some examples, the deformation prevention unit may further include an adhesive layer provided on an outer side of the base part and adhered to the case.

In some examples, the adhesive layer may include at least one of a thermosetting adhesive, a thermoplastic adhesive, a single-component epoxy adhesive, and a two-component epoxy adhesive.

In some examples, the base part may include: a filter member having insulating and flame-retardant properties; and a base cover that accommodates the filter member, is connected to the protrusion support part, and supports the case.

In some examples, the deformation prevention unit may further include an adhesive layer provided on an outer side of the base cover to adhere the base cover to the case.

In some examples, the protrusion support part may be formed as a square frame and may support the outer rim of the base in both length and width directions of the case.

In some examples, a cross section of the protrusion support part may be square or elliptical.

In some examples, the protrusion support part may include: an extension member that protrudes in at least one of a length and a width direction of the base part; and a support member that extends upward and downward from the extension member and has a curved surface that corresponds to an outer shape of the case and supports the case.

In some examples, the case may be provided on the upper and lower sides of the base part, and the protrusion support part may protrude from upper and lower sides of the base part to support the outer rim of the case on the upper and lower sides of the base part.

An exemplary secondary battery according to one embodiment of the present disclosure for solving the technical problem may include: an electrode assembly including a first electrode plate, a second electrode plate, and a separator; a soft case for accommodating the electrode assembly; and a deformation prevention unit shaped to wrap around both ends of the case and prevent deformation of the case.

In some examples, the deformation prevention unit may include: a base part in contact with at least one of upper and lower sides of the case; and a support frame provided on the longitudinal sides of the base part and having a recess portion in which an end of the case is seated.

In some examples, the support frame may include: a support body having a seating channel into which the base part is inserted and seated; and an extension body connected to at least one of the upper and lower sides of the support body and forming the recess portion.

In some examples, the secondary battery includes a first case and a second case and the recess portion includes a first recess portion and a second recess portion, and the extension body may include an upper body extending upwardly from the support body and forming the first recess portion in which an end of the first case located on the upper side of the base part is seated; and a lower body extending downwardly from the support body and forming the second recess portion in which an end of the second case located on the lower side of the base part is seated.

According to the present disclosure, because the face-to-face distance between internal components of a secondary battery can be maintained constant, the charging and discharging efficiency of the battery can be improved and the service life of the secondary battery can be extended.

In addition, by effectively preventing structural deformation of a secondary battery case, the operational reliability and safety of the secondary battery can be improved.

However, the effects achievable through the present disclosure are not limited to those described above, and other technical effects not mentioned can be clearly understood by those skilled in the art from the description provided below.

### BRIEF DESCRIPTION OF DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is an exploded perspective view of a secondary battery according to an embodiment of the present disclosure.

FIG. 2 is a combined perspective view of a secondary battery according to an embodiment of the present disclosure.

FIG. 3 is a plan view of an electrode assembly and a case according to an embodiment of the present disclosure.

FIG. 4 is a front cross-sectional view of an electrode assembly and a case according to an embodiment of the present disclosure.

FIG. 5 is a front view of a secondary battery according to an embodiment of the present disclosure.

FIG. 6 is a partial cutaway perspective view of a deformation prevention unit according to an embodiment of the present disclosure.

FIG. 7 is a cross-sectional view showing a base part and an adhesive layer according to an embodiment of the present disclosure.

FIG. 8 is a front view showing a state in which a case is located on the upper and lower sides of the deformation prevention unit according to an embodiment of the present disclosure.

FIG. 9 is a perspective view showing a deformation prevention unit according to another embodiment of the present disclosure.

FIG. 10 is a front view showing a state in which a case is located on the upper and lower sides of the deformation prevention unit according to another embodiment of the present disclosure.

FIG. 11 is a perspective view showing a deformation prevention unit according to another embodiment of the present disclosure.

FIG. 12 is a front view showing a deformation prevention unit according to another embodiment of the present disclosure.

FIG. 13 is a perspective view showing a state in which a base part and a support frame are separated, according to another embodiment of the present disclosure,.

FIG. 14 is a perspective view showing a state in which the base part and the support frame are combined, according to another embodiment of the present disclosure,.

FIG. 15 is a perspective view showing the support frame according to another embodiment of the present disclosure.

FIGS. 16A and 16B are perspective views showing a battery pack including an exemplary secondary battery according to the present disclosure.

FIGS. 17A and 17B are a perspective view and a side view showing vehicles including an exemplary battery pack according to the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

In addition, the terms “comprise” or “include” and/or “comprising” or “including,” when used in this specification, specify the presence of stated shapes, numbers, steps, operations, members, elements, and/or groups thereof, but do not preclude the presence or addition of one or more other shapes, numbers, steps, operations, members, elements, and/or groups thereof.

Additionally, for the purpose of facilitating an understanding of the invention, the attached drawings are not depicted to actual scale; dimensions of some components may be exaggerated for clarity. Also, identical components in different embodiments may be denoted with the same reference numerals.

When two objects of comparison are referred to as being the same, it means the two objects are “substantially the same.” Thus, substantially the same may include a deviation that is considered low in the art, for example, a deviation of less than 5%. In addition, when a parameter is said to be uniform in a certain region, it may mean that the parameter is uniform from an average perspective.

Although “first,” “second,” and the like are used to describe various components, these components are of course not limited by these terms. These terms are only used to distinguish one component from other components, and unless otherwise stated, a first component could be termed a second component.

Throughout the specification, unless specifically stated otherwise, each component may be singular or plural.

When an arbitrary element is referred to as being “disposed above (or below)” or “disposed on (or under)” a component, it may mean not only that the arbitrary element is disposed in contact with an upper surface (or lower surface) of the component, but also that other elements may be interposed between the component and the arbitrary element disposed on (or under) the component.

When a component is described as being “connected,” “coupled,” or “joined” to another component within this patent document, it is understood that the components may be directly connected or joined to each other. However, it should also be interpreted that an intervening component may be interposed between them, or that each component may be “connected,” “coupled,” or “joined” through another intermediary component. Furthermore, when one part is described as being electrically connected (electrically coupled) to another, this encompasses not only a direct connection but also includes scenarios where other elements are positioned in between, facilitating an indirect connection.

Throughout this specification, the term ‘A and/or B’ should be interpreted as meaning either A, B, or both A and B, unless an alternative interpretation is explicitly stated. Thus, ‘and/or’ encompasses any and all possible combinations of the items listed. Similarly, when ‘C to D’ is mentioned, it is understood to mean C or more, up to and including D, unless noted otherwise. The terminology employed herein is intended solely for describing specific embodiments and should not be regarded as limiting the scope of this disclosure.

In the present disclosure, a length direction (D) may be referred to as a first direction or Y, a width direction (W) may be referred to as a second direction or X, and an up-down direction (H) may be referred to as a third direction or Z.

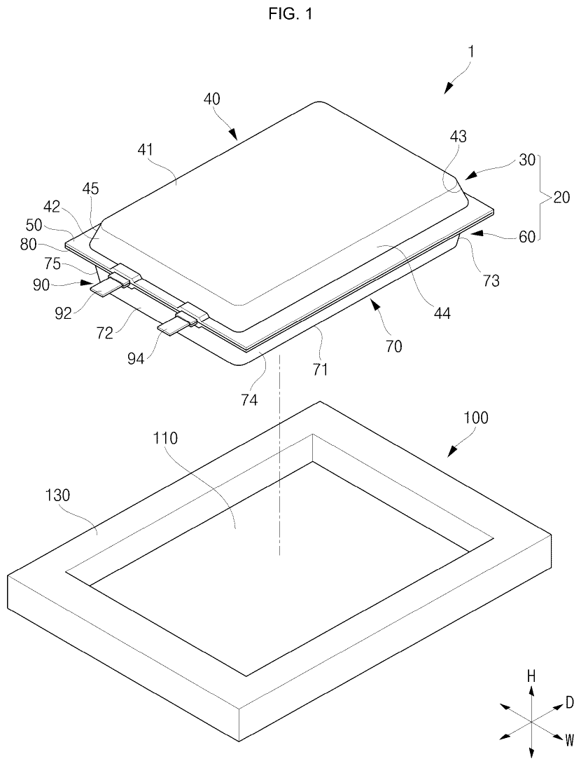

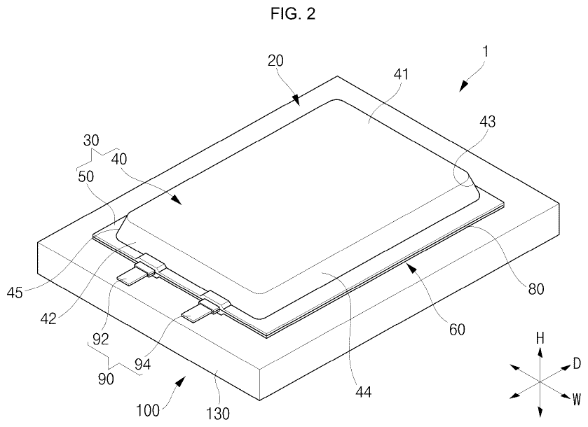

A secondary battery 1 according to an embodiment of the present disclosure will be described with reference to the drawings. FIG. 1 is an exploded perspective view of a secondary battery 1 according to an embodiment of the present disclosure, and FIG. 2 is a combined perspective view of the secondary battery 1 according to an embodiment of the present disclosure. As shown in FIGS. 1 and 2, the secondary battery 1 according to an embodiment of the present disclosure includes a case 20 and a deformation prevention unit 100. In addition, the secondary battery 1 further includes an electrode assembly 10 and a terminal portion 90. The electrode assembly 10 is accommodated inside the case 20. The deformation prevention unit 100 is positioned to contact at least one of an upper side 41 and a lower side 71 of the case 20 and support all or part of the rim of the case 20 to thereby preventing deformation of the case 20.

The case 20 may be formed in various shapes within the technical concept of accommodating the electrode assembly 10. The case 20 may include a soft film. In some examples, the case 20 may include an aluminum laminate sheet. The case 20 may be a pouch that is deformable. The pouch includes a space formed therein and may be formed in various shapes within the technical concept of wrapping around the electrode assembly 10. The pouch may be made of a soft film. For example, the pouch may be a rectangular film extending in the length direction (D), with one side thereof being folded to have an upper cover 30 and a lower cover 60.

The case 20 may be made, for example, of either a three-layer structure of nylon or PET/aluminum/cast polypropylene (CPP) or stainless steel.

A three-layer structure case will now be described. The three-layer structure case may include an outer layer (e.g., nylon or polyethylene terephthalate (PET)), an intermediate layer (e.g., aluminum), and an inner layer (e.g., CPP).

The outer layer provides mechanical strength and chemical resistance, thereby protecting the inside of a battery from the external environment. The material of the outer layer has high barrier properties and thereby serves to block the inflow of moisture and gas to the inside of the battery.

The intermediate layer provides an electromagnetic shielding function and improves the electrical stability of a battery. In addition, the intermediate layer helps heat dissipation of the battery, thereby reducing the risk of overheating.

The inner layer has excellent thermal bonding properties and improves adhesion to a battery to thereby help ensure close contact with the internal components of the battery and maintaining structural integrity.

When the case 20 is made of stainless steel, it provides excellent durability and corrosion resistance and may have greatly improved structural strength. Stainless steel also contributes to stabilizing the electrical and thermal performance of a battery and can ensure the performance of the battery, especially under high temperature or extreme environmental conditions.

The upper cover 30 is located on the upper side of the electrode assembly 10 and the lower cover 60 is located on the lower side of the electrode assembly 10. The upper cover 30 and the lower cover 60 can be connected to each other by a folded portion. Of course, various modifications are possible, including, for example, the upper cover 30 and the lower cover 60 being spaced apart as separate members and then being connected with the electrode assembly 10 interposed therebetween.

In the present disclosure, a pouch is not limited to an integral form in which the upper cover 30 and the lower cover 60 are formed from a single film. But for the convenience of explanation, the following description will be given as an example in which the upper cover 30 and the lower cover 60 are formed on a single rectangular film.

The upper cover 30 may be formed into various shapes within the technical concept of covering or wrapping the upper portion of the electrode assembly 10. The upper cover 30 according to an embodiment of the present disclosure includes a first cover 40 and a first sealing portion 50.

The first sealing portion 50 provided on the upper cover 30 may be fixed while being in contact with the second sealing portion 80 provided on the lower cover 60. The first sealing portion 50 and the second sealing portion 80 may be fixed by various bonding methods, including heat welding in a state of the second sealing portion 80 is in contact with the lower side of the first sealing portion 50.

The first cover 40 may be shaped to wrap around the upper side of the electrode assembly 10. The first cover 40 may include an upper side surface 41, an upper front connection surface 42, an upper rear connection surface 43, an upper first side surface 44, and an upper second side surface 45.

The upper side surface 41 may be formed as a flat surface on the upper side of the first cover 40. The upper side surface 41 may also be formed as a curved surface that is close to a flat surface. The upper side surface 41 is provided at a higher position than the first sealing portion 50, and the upper front connection surface 42 is located on a side (left side in FIG. 1) in the length direction (D) of the upper side surface 41. The upper rear connection surface 43 is located on the other side (right side in FIG. 1) in the length direction (D) of the upper side surface 41.

The upper front connection surface 42 may be formed in various shapes within the technical concept of connecting one end in the length direction (D) of the upper side surface 41 and the first sealing portion 50. The upper front connection surface 42 may be formed as an inclined surface or a curved surface. The upper front connection surface 42 may be provided so as to be inclined downward from one end of the upper side surface 41 toward the first sealing portion 50. In addition, the upper front connection surface 42 may also form a convex curved surface outward from the upper cover 30.

The upper rear connection surface 43 may be formed in various shapes within the technical concept of connecting the other end in the length direction (D) of the upper side surface 41 and the first sealing portion 50. The upper rear connection surface 43 may be an inclined surface or a curved surface. The upper rear connection surface 43 may be provided so as to be inclined downward from the other end of the upper side surface 41 toward the first sealing portion 50. In addition, the upper rear connection surface 43 may also form a convex curved surface outward from the upper cover 30.

The upper first side surface 44 may be formed into various shapes within the technical concept of connecting one end in the width direction (W) of the upper side surface 41 and the first sealing portion 50. The upper first side surface 44 may be an inclined surface or a curved surface. The upper first side surface 44 may be positioned to be inclined downward from one end in the width direction (W) of the upper side surface 41 toward the first sealing portion 50. In addition, the upper first side surface 44 may also form a convex curved surface outward from the upper cover 30.

The upper second side surface 45 may be formed in various shapes within the technical concept of connecting the other end in the width direction (W) of the upper side surface 41 and the first sealing portion 50. The upper second side surface 45 may be an inclined surface or a curved surface. The upper second side surface 45 may be positioned to be inclined downward from the other end in the width direction (W) of the upper side surface 41 toward the first sealing portion 50. In addition, the upper second side surface 45 may also form a convex curved surface outward from the upper cover 30.

The first sealing portion 50 is connected to the first cover 40 and forms the rim of the upper cover 30. The first sealing portion 50 is located on the outer side of the first cover 40 and may be in a plane that is parallel to the plane as the upper side surface 41 of the first cover 40.

The lower cover 60 may be integrally connected to the upper cover 30 and folded, but may be implemented in various other ways, including, for example, being formed as a separate member from the upper cover 30. The lower cover 60 according to an embodiment of the present disclosure includes a second cover 70 and a second sealing portion 80. The upper cover 30 and the lower cover 60 may be symmetric with the same or similar shapes. The upper cover 30 may form a plane, and the electrode assembly 10 may be positioned on the inner side of the lower cover 60. The upper cover 30 according to an embodiment of the present disclosure is positioned above the terminal portion 90 (which will be described below) and the lower cover 60 is positioned below the terminal portion 90. The upper cover 30 has an upwardly convex shape and the lower cover 60 has a downwardly convex shape.

The second sealing portion 80 has the same shape as the first sealing portion 50 and is fixed in contact with the lower side of the first sealing portion 50.

The second cover 70 is connected to the lower part of the second sealing portion 80 and is shaped to wrap around the outer side of the electrode assembly 10 together with the first cover 40. The second cover 70 according to an embodiment of the present disclosure includes a lower side surface 71, a lower front connection surface 72, a lower rear connection surface 73, a lower first side surface 74, and a lower second side surface 75.

The lower side surface 71 is positioned in the same planar shape as the upper side surface 41 and is located below the upper side surface 41.

The lower front connection surface 72 may be formed in various shapes within the technical concept of connecting one end in the length direction (D) of the lower side surface 71 and the second sealing portion 80. The lower front connection surface 72 may be inclined upward from one end of the lower side surface 71 toward the second sealing portion 80. Also, the lower front connection surface 72 may be a convex curved surface outward from the lower cover 60.

The lower rear connection surface 73 may be formed in various shapes within the technical concept of connecting the end in the length direction (D) of the lower side surface 71 and the second sealing portion 80. The lower rear connection surface 73 may be formed as an inclined surface or a curved surface. The lower rear connection surface 73 may be inclined upward from the other end of the upper side surface 41 toward the second sealing portion 80. Also, the lower rear connection surface 73 may be a convex curved surface toward outside of the lower cover 60.

The lower first side surface 74 may be formed in various shapes within the technical concept of connecting one end in the width direction (W) of the lower side surface 71 and the second sealing portion 80. The lower first side surface 74 may be inclined upward from an end in the width direction (W) of the lower side surface 71 toward the second sealing portion 80. Also, the lower first side surface 74 may also form a convex curved surface outward from the lower cover 60.

The lower second side surface 75 may be formed in various shapes within the technical concept of connecting the other end in the width direction (W) of the lower side surface 71 and the second sealing portion 80. The lower second side surface 75 may be inclined downward from the other end in the width direction (W) of the lower side surface 71 toward the second sealing portion 80. Also, the lower second side surface 75 may be a convex curved surface outward from the lower cover 60.

The terminal portion 90 protruding outward from the case 20 is electrically connected to the electrode assembly 10. The terminal portion 90 includes a first terminal 92 electrically connected to a first electrode plate 12 of the electrode assembly 10 (which will be described later) and a second terminal 94 electrically connected to a second electrode plate 14. The terminal portion 90 is located between the first sealing portion 50 and the second sealing portion 80. An insulating tape for insulation from the case 20 may be positioned on the first terminal 92 and the second terminal 94.

The case 20 may be formed from a soft film, but also may be made of a material other than a soft film. Since the shape of the pouch-shaped case 20 may be deformed by an external force, the deformation prevention unit 100 may be positioned to be in contact with the case 20, thereby preventing deformation of the shape of the case 20. When the deformation prevention unit 100 is positioned to the lower side of the case 20, the deformation prevention unit 100 is in contact with all or part of the lower cover 60, thereby preventing deformation of the lower cover 60.

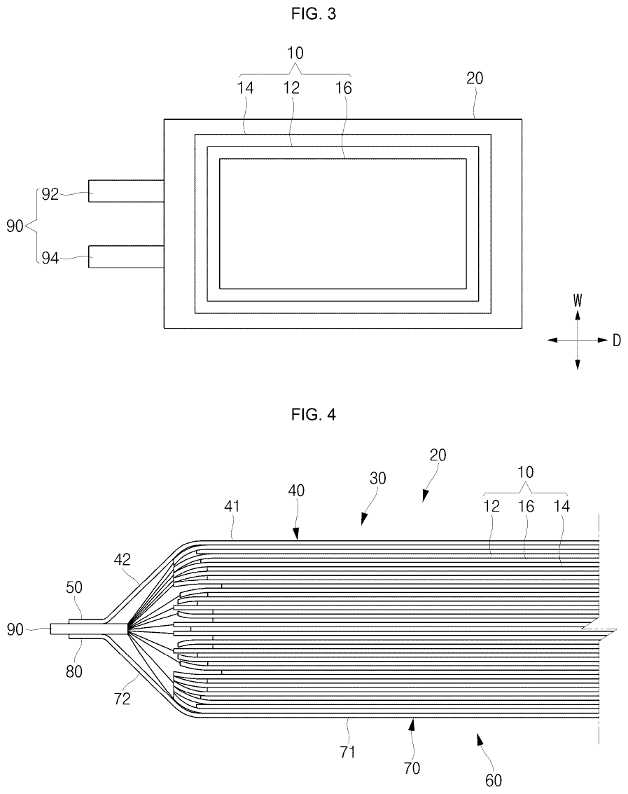

FIG. 3 is a plan view of the electrode assembly 10 and the case 20, according to an embodiment of the present disclosure, and FIG. 4 is a front cross-sectional view of the electrode assembly 10 and the case 20, according to an embodiment of the present disclosure. As shown in FIGS. 3 and 4, the electrode assembly 10 may include a first electrode plate 12, a second electrode plate 14, and a separator 16. The electrode assembly 10 may be accommodated inside a pouch together with electrolyte. The electrolyte may be composed of a lithium salt such as LiPF6, LibF4, etc. in an organic solvent such as ethylene carbonate (EC), propylene carbonate (PC), diethyl carbonate (DEC), ethyl methyl carbonate (EMC), dimethyl carbonate (DMC), etc.

According to an embodiment of the present disclosure, the first electrode plate 12 may be a positive electrode plate, and the second electrode plate 14 may be a negative electrode plate. The second electrode plate 14 may have a larger area than the first electrode plate 12.

The positive electrode plate may be made of aluminum (Al), and at least one surface of the positive electrode plate is coated with a positive electrode active material made of a transition metal oxide. In addition, a positive electrode uncoated portion that is not coated with the positive electrode active material may be provided at one side of the positive electrode plate.

The negative electrode plate may be made of copper (Cu) or nickel (Ni), and at least one surface of the negative electrode plate is coated with a negative electrode active material such as graphite or carbon. In addition, a negative electrode uncoated portion that is not coated with the negative electrode active material may be provided at one side of the negative electrode plate.

A space is formed between the ends in the length direction (D) of the negative electrode plate and the case 20, which makes the case 20 more deformable toward the electrode assembly 10. To prevent or minimize deformation of the case 20 and the electrode assembly 10, the deformation prevention unit 100 is installed on the outer side of the case 20.

The separator 16 may be made of polyethylene (PE) or polypropylene (PP), but the present disclosure is not limited to these examples. The separator 16 may prevent electrical shorting between the positive electrode plate and the negative electrode plate, and lithium ions may move through the separator 16.

The electrode assembly 10 having the aforementioned configuration may be configured as a jelly roll or a stack.

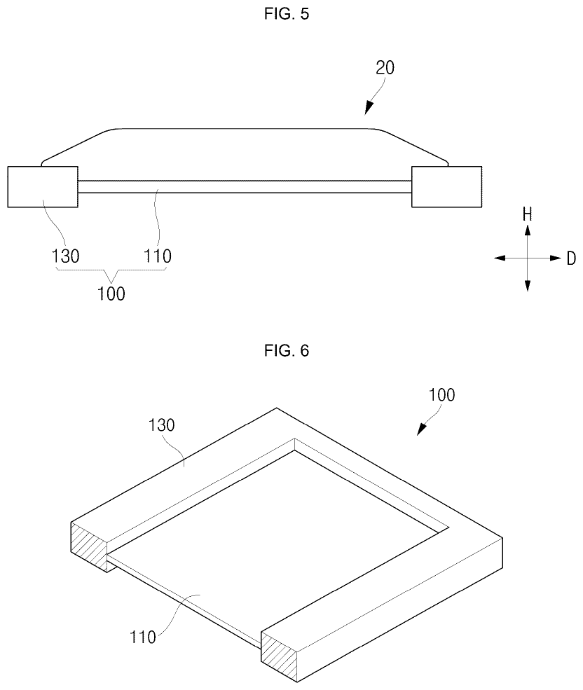

FIG. 5 is a front view of a secondary battery 1 according to an embodiment of the present disclosure, and FIG. 6 is a partial cutaway perspective view of a deformation prevention unit 100 according to an embodiment of the present disclosure. As shown in FIGS. 5 and 6, the deformation prevention unit 100 is in contact with the outer surface of the case 20. The deformation prevention unit 100 may be formed in various shapes within the technical concept of restraining deformation of the case 20.

During the operation of a lithium ion battery, a volume change of the battery may occur, which may deform the case 20. Due to the deformation of the secondary battery 1, the distance between the first electrode plate 12 and the second electrode plate 14 may become non-uniform, which may cause non-uniform charging conditions. Portions of the case 20 of the secondary battery 1 that are liable to deform are both ends in the length direction (D) of the of the case 20. In addition, both ends in the width direction (W) of the of the case 20 may also deform. Therefore, the deformation prevention unit 100 is to support or wrap both ends in the length direction (D) of the case 20 thereby preventing or reducing deformation of the case 20 of the secondary battery 1.

Although the electrode assembly 10, the case 20, and the deformation prevention unit 100 have been described in an embodiment of the present disclosure as components of the secondary battery 1, this is only for convenience of explanation and the present disclosure is not limited thereto. As an example, the secondary battery 1 is a pouch including the electrode assembly 10 and the case 20, and the secondary battery 1 may be combined with the deformation prevention unit 100 to form a battery module or a battery pack.

The deformation prevention unit 100 may be a tape or a foam material and may be in contact with at least one of the ends in the length direction (D) and the width direction (W) of the case 20 that are deformable.

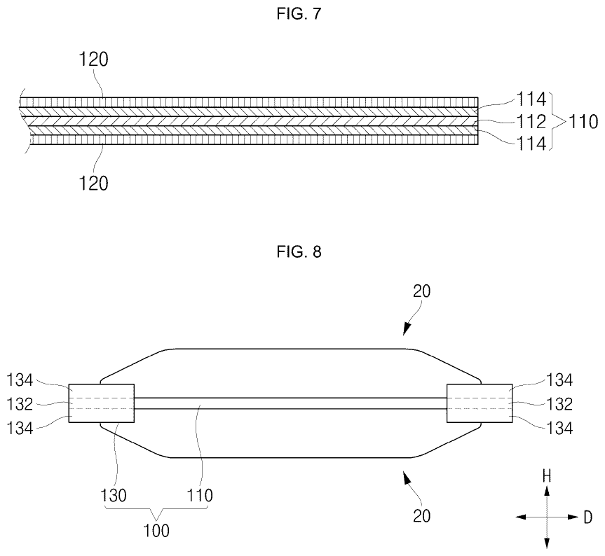

The deformation prevention unit 100 according to an embodiment of the present disclosure includes a base part 110 and a protrusion support part 130. In addition, the deformation prevention unit 100 may further include an adhesive layer 120 (see FIG. 7).

The base part 110 and the protrusion support part 130 constituting the deformation prevention unit 100 may be formed by various manufacturing methods. The base part 110 and the protrusion support part 130 may be integrally formed, in which case the two components are formed continuously through a single manufacturing process. In such a case, the two components have high structural integrity and strength. The integral structure reduces the possibility of weakness at internal joints and can simplify manufacturing.

In another embodiment, the base part 110 and the protrusion support part 130 may be separately molded and then assembled. In such a case, the respective parts are manufactured individually by using optimized materials and processes and then combined with each other during a subsequent assembling process. The separate molding method facilitates a design change according to the characteristics of the respective parts. In addition, since only the relevant parts need to be replaced during a maintenance operation, maintenance costs can be reduced.

When the case 20 is located on the upper side of the base part 110 shown in FIG. 5, the protrusion support part 130 provided on the rim of the base part 110 supports the lower part of the case 20, thereby preventing deformation of the case 20.

The base part 110 may be formed in various shapes within the technical concept of contacting the outer side of the case 20. The base part 110 may be shaped to face the upper side surface 41 or the lower side surface 71 of the case 20. As shown in FIG. 6, the base part 110 may be formed in a flat shape.

In examples, the base part 110 may be formed from a film having insulating and flame-retardant properties. The film that forms the base part 110 may include at least one of polyimide (PI), polyether ether ketone (PEEK), and polytetrafluoroethylene (PTFE). Polyimide (PI) maintains stable performance even at high temperatures and has thermal and electrical insulation properties. Polyimide (PI) can be widely used in high-temperature working environments or in batteries where high voltage is applied. Polyether ether ketone (PEEK) is a high-performance plastic having very high mechanical strength and chemical resistance, and can withstand high temperatures, thereby increasing the durability of the base part 110. Polytetrafluoroethylene (PTFE) (also sold under the tradename TEFLON®) and has excellent chemical stability and a low coefficient of friction.

In addition, the base part 110 may include at least one of mica, a polymer tape, and a pressure-sensitive tape. Mica has excellent electrical insulation and thermal stability. Due to high thermal resistance, mica may function as an additional protective layer when a battery overheats. The polymer tape is made of a high-molecular material and has excellent flexibility and adhesiveness, as well as good mechanical strength and chemical resistance. Therefore, the base part 110 may be stably maintained while being in contact with the upper side surface 41 or the lower side surface 71 of the case 20. The pressure-sensitive tape exhibits adhesiveness when pressure is applied and has strong adhesive properties as well as being easy to remove.

The base part 110 may be formed as a single layer or may be composed of multiple layers, as necessary. In addition, the base part 110 may be manufactured as a soft film or may be manufactured in the shape of a hard plate.

FIG. 7 is a cross-sectional view showing a base part 110 and an adhesive layer 120, according to an embodiment of the present disclosure. As shown in FIG. 7, the base part 110 may include a filter member 112 having insulation and flame-retardant properties, and a base cover 114 that accommodates the filter member 112, is connected to the protrusion support part 130, and supports the case 20. The base cover 114 is laminated on the upper and lower sides of the filter member 112. The adhesive layer 120 may be provided on the upper and lower sides of the base cover 114.

The filter member 112 has high insulation and flame-retardant properties, and can protect components of another adjacently placed secondary battery from electrical or chemical risks that may occur inside the secondary battery 1. The filter member 112 can prevent problems that may occur, particularly when there is overvoltage or overheating, and the filter member can make the secondary battery 1 safer.

The base cover 114 wraps the filter member 112 and thereby functions to prevent damage to the filter member 112. Since the base cover 114 is connected to the protrusion support part 130, the structure of the deformation prevention unit 100 can be strengthened to thereby make the structure safer.

The adhesive layer 120 may be provided on the upper and lower sides of the base cover 114 and serve to attach the base cover 114 to the outer side of the case 20. Accordingly, the deformation prevention unit 100 is more stably fixed to the outer side of the case 20. Since the deformation prevention unit 100 is maintained in a state of being fixed to the case 20 by using the adhesive layer 120, deformation of the case 20 may be prevented. Accordingly, the overall reliability and lifespan of the secondary battery 1 can be improved. The secondary battery 1 having the case 20 and the deformation prevention unit 100 combined with each other may be suitable for applications requiring high reliability, such as electric vehicles.

The adhesive layer 120 is provided on the outer side of the base part 110 and may be formed into various shapes within the technical concept of being adhered to the case 20. The adhesive layer 120 may be a single layer laminated on the outer side of the base part 110. Alternatively, the adhesive layer 120 may be provided as multiple layers laminated on the outer side of the base part 110. As shown in FIG. 7, the adhesive layer 120 may be provided on the upper and lower sides of the base part 110 having the filter member 112 and the base cover 114. The adhesive layer 120 is provided on the outer side of the base cover 114 and may serve to adhere the base cover 114 and the case 20.

In some examples, the adhesive layer 120 may include any of a thermosetting adhesive, a thermoplastic adhesive, a single-component epoxy adhesive, a two-component epoxy adhesive, a silicone adhesive, an acrylate adhesive, a urethane adhesive, a resin, and a rubber adhesive.

Thermoplastic adhesives are adhesives that soften when heated, harden when cooled, and can be reprocessed through repeated heating and cooling. Thermoplastic adhesives have the advantage of being reusable, easy to modify, and can generally be used on a variety of materials such as plastics, metals, and ceramics.

Single-component epoxy adhesives are epoxy-based adhesives that do not require mixing prior to use. Such adhesives are easy to store and handle. Single-component epoxy adhesives are stable when stored, but when a certain temperature is reached, the curing process begins Single-component epoxy adhesives provide high adhesion, mechanical strength, and excellent chemical resistance.

Two-component epoxy adhesives are epoxy-based adhesives that use a mixture of two components, a resin and a hardener. The adhesives, activated by the mixture of resin and hardener, provide strong bonding strength and excellent durability. These adhesives also maintain excellent performance over a wide range of temperatures and environmental conditions.

Thermosetting adhesives are adhesives that harden under the influence of heat and time, and such adhesives can have high resistance to electrolytes. Epoxy adhesives are thermosetting adhesives and can maintain stability against electrolytes.

Silicone adhesives have high chemical stability and can be used in various environments. Silicone adhesives have little interaction with electrolytes and can maintain stable adhesion.

Acrylic adhesives have a fast curing speed, excellent heat resistance, and are made of chemically stable materials.

Urethane adhesives have excellent heat and chemical resistance, but some types of urethane adhesives may have properties that limit their interaction with electrolytes.

Rubber adhesives are flexible and chemically resistant, and thus can be used in a variety of environments. Some rubber adhesives may have less interaction with electrolytes.

As shown in FIGS. 1 and 6, the protrusion support part 130 is provided along the outer rim of the base part 110 and may be shaped to support or wrap the rim of the case 20. For example, the protrusion support part 130 is shaped of a square frame and may support the rim on both sides in the length direction (D) of the case 20 and the width direction (W). The protrusion support part 130 may include a polymer resin and may be made of various materials, such as metal, ceramic, composite materials, reinforced glass fiber, carbon fiber reinforced polymer (CFRP), a hybrid structure of metal and plastic, and the like. These materials provide particularly high mechanical strength and durability and have excellent resistance to environmental factors. Thus, these materials can effectively prevent deformation of the case 20. The polymer resin may be one or more of polyimide resin, polyethylene resin, polypropylene resin, polybutylene resin, polystyrene resin, polyethylene terephthalate resin, polycarbonate resin, and polybutadiene resin.

The protrusion support part 130 may be provided on both ends in the length direction (D) of the base part 110. In a specific example embodiment, the protrusion support part 130 may be on both ends in the width direction (W) of the base part 110. Accordingly, the case 20 in contact with the deformation prevention unit 100 may be more effectively supported and protected. In addition, the protrusion support part 130 may protrude in either upward or downward from the base part 110 or may protrude both upward and downward. When case 20 is positioned above the deformation prevention unit 100, and another case 20 is positioned below the deformation prevention unit 100, the protrusion support part 130 protrudes upward and downward from the base part 110.

As shown in FIG. 1, when the case 20 of the secondary battery 1 is located above the deformation prevention unit 100, the lower cover 60 of the case 20 can be protected by the deformation prevention unit 100.

The protrusion support part 130 located at one end in the length direction (D) of the base part 110 may be provided in contact with or spaced from the lower front connection surface 72 of the lower cover 60. The shape of the protrusion support part 130 facing the lower front connection surface 72 may be an inclined surface or a curved surface corresponding to the lower front connection surface 72. When necessary, the adhesive layer 120 may be provided on the protrusion support part 130 facing the lower front connection surface 72, and, thus, the protrusion support part 130 can be fixed to the outer side of the lower front connection surface 72.

The protrusion support part 130 located at the other end in the length direction (D) of the base part 110 may be provided in contact with or spaced from the lower rear connection surface 73 of the lower cover 60. The shape of the protrusion support part 130 facing the lower rear connection surface 73 may be an inclined surface or a curved surface corresponding to the lower rear connection surface 73. When necessary, the adhesive layer 120 may be provided on the protrusion support part 130 facing the lower rear connection surface 73. Thus, the protrusion support part 130 can be fixed to the outer side of the lower rear connection surface 73.

In the same manner as described above, the protrusion support part 130, which is located at each end in the width direction (W) of the base part 110, is provided in contact with or spaced from the lower first side surface 74 and the lower second side surface 75 of the lower cover 60 to thereby preventing deformation of the lower cover 60.

When the case 20 of the secondary battery 1 is located on the upper side of the deformation prevention unit 100, the deformation prevention unit 100 is shaped to wrap around the outer side of the lower cover 60. The deformation prevention unit 100 thereby prevents deformation of the lower cover 60. When the case 20 of the secondary battery 1 is located on the lower side of the deformation prevention unit 100, the deformation prevention unit 100 is shaped to wrap around the outer side of the upper cover 30. The deformation prevention unit 100 thereby prevents deformation of the upper cover 30. Since the function of the deformation prevention unit 100 of preventing deformation of the upper cover is the same as the function of preventing deformation of the lower cover, a detailed description thereof will be omitted.

As shown in FIG. 6, in some examples, the cross-section of the protrusion support part 130 may be either a square or an oval. Of course, the shape of the protrusion support part 130 and the cross-section of the protrusion support part 130 may be modified according to the shape of the case 20 of the secondary battery 1.

FIG. 8 is a front view of the case 20 positioned on the upper and lower sides of the deformation prevention unit 100 according to an embodiment of the present disclosure. As shown in FIG. 8, the case 20 of the secondary battery 1 may be located on the upper and lower sides of the deformation prevention unit 100. The upper side surface 41 of the base part 110 is provided in contact with the lower side of the case 20 located on the upper side of the base part 110. The lower side surface 71 of the base part 110 is installed is in contact with the upper side of the case 20 located on the lower side of the base part 110. In addition, the protrusion support part 130 supports the inclined surface or curved surface shape on the rim of the case 20 located on the upper side of the base part 110 to thereby prevent or minimize deformation of the case 20.

As described above, the case is positioned on the upper and lower sides of the base part 110 and the protrusion support part 130 protrudes from the upper and lower sides of the base part 110. Thus, the rim of the case 20 positioned on the upper and lower sides of the base part 110 is supported.

The protrusion support part 130 provided on the rim of the base part 110 may be formed as a single member, and may also include of an extension member 132 and a support member 134. The extension member 132 protrudes in at least one of the length direction (D) and the width direction (W) of the base part 110. Like the base part 110, the extension member 132 may be a plate extending in a horizontal direction. The support member 134 extends above and below the extension member 132, has a curved surface corresponding to the outer shape of the case 20, and may be formed into various shapes within the technical concept of supporting the case 20.

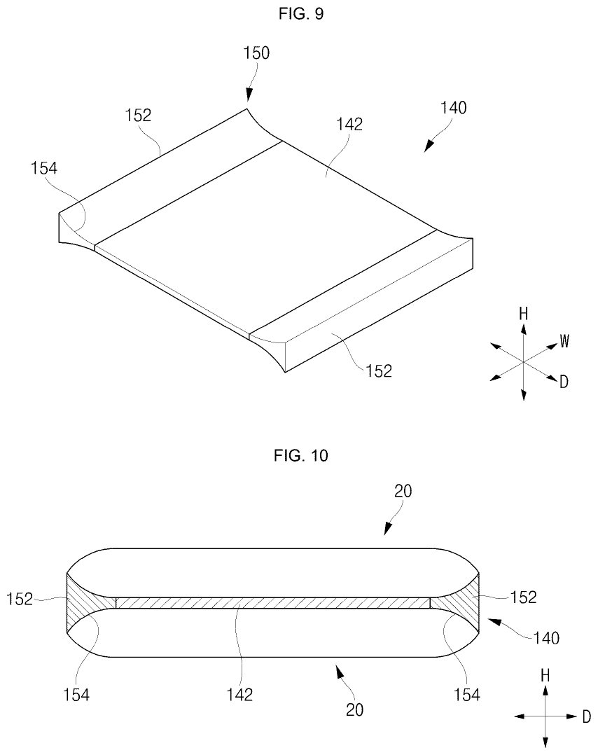

FIG. 9 is a perspective view showing a deformation prevention unit 140 according to another embodiment of the present disclosure, and FIG. 10 is a front view showing a state in which cases 20 are positioned on the upper and lower sides of the deformation prevention unit 140 according to another embodiment of the present disclosure. As shown in FIG. 9, the deformation prevention unit 140 is shaped to wrap around both ends of the cases 20 and may be formed in various shapes within the technical concept of restraining deformation of the case 20. For example, the deformation prevention unit 140 may include a base part 110 and a protrusion support part 130.

The base part 142 is provided in contact with at least one of the upper side surface 41 and the lower side surface 71 of the cases 20. Thus, deformation of the body of the cases 20 can be prevented. The base part 142 may be a soft film or a plate. Since the base part 142 is the same as or similar to that of the previous embodiment of the present disclosure, a detailed description thereof is omitted.

In the protrusion support part 150, the first protrusion part 152 may be provided on both ends in the length direction (D) of the base part 142. When both ends of the cases 20 facing the first protrusion part 152 are formed in a curved shape, a guide curved surface 154 is formed on the first protrusion part 152 corresponding thereto. The guide curved surface 154 may be provided in contact with a curved connecting surface located on both ends in the length direction of the cases 20.

As shown in FIG. 10, the cases 20 of the secondary battery 1 are provided on the upper and lower sides of the deformation prevention unit 140. The guide curved surface 154 located on the upper side of the first protrusion part 152 is shaped to wrap around the lower end of the case 20 located on the upper side. The guide curved surface 154 located on the lower side of the first protrusion part 152e shaped to wrap around the upper end of the case 20 located on the lower side.

FIG. 11 is a perspective view of a deformation prevention unit 140 according to another embodiment of the present disclosure. As shown in FIG. 11, the protrusion support part 150 may further include a second protrusion part 156 installed at both ends in the width direction (W) of the base part 142. The second protrusion part 156 is shaped to wrap around the outer side of the case 20 together with the first protrusion part 152. The second protrusion part 156 is installed at both ends in the width direction (W) of the base part 142 and protrudes upward and downward from the base part 142. Therefore, the second protrusion part 156 protects both ends in the width direction (W) of the case 20 located at the upper and lower sides of the deformation prevention unit 140 thereby preventing deformation of the case 20.

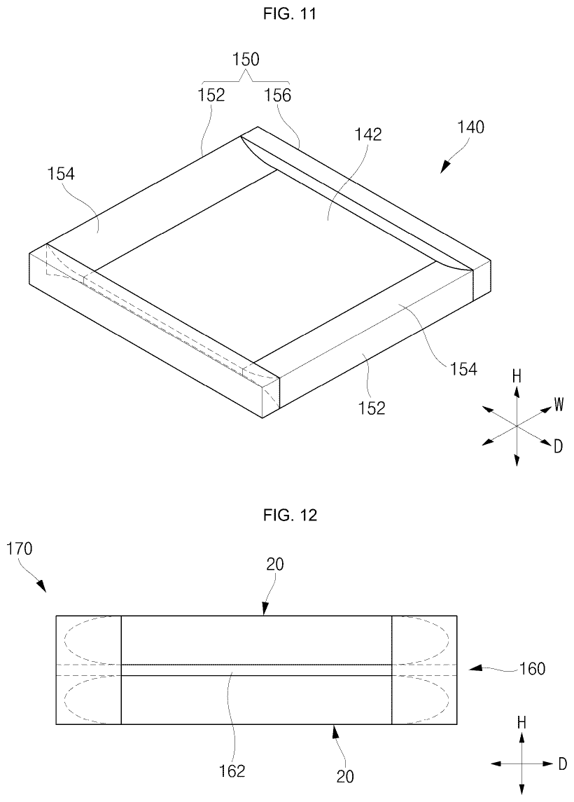

FIG. 12 is a front view showing a deformation prevention unit 160 according to another embodiment of the present disclosure. As shown in FIG. 12, the deformation prevention unit 160 according to another embodiment of the present disclosure may be shaped to wrap around both ends in the length direction (D) of cases 20 of the secondary battery 1, stacked in the up-down direction (H).

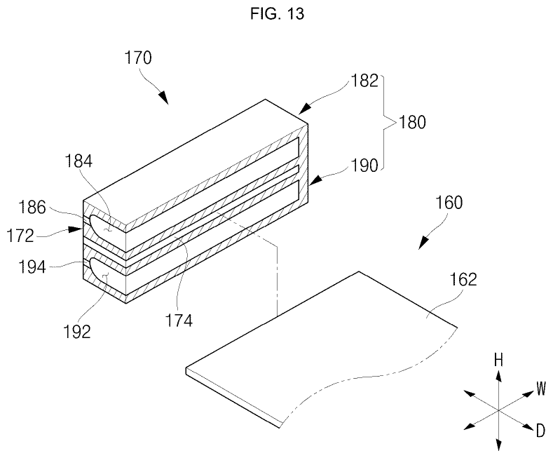

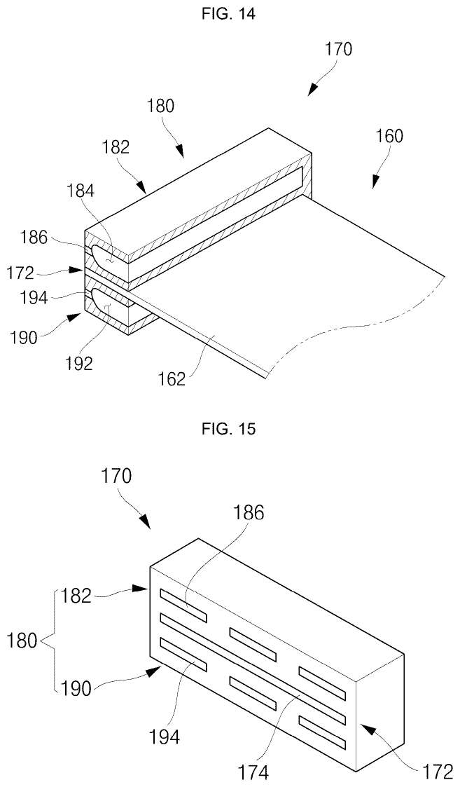

FIG. 13 is a perspective view showing a separated state of a base part 162 and a support frame 170 according to another embodiment of the present disclosure, FIG. 14 is a perspective view showing a combined state of the base part 162 and the support frame 170, according to another embodiment of the present disclosure, and FIG. 15 is a perspective view showing the support frame 170 according to another embodiment of the present disclosure. As shown in FIGS. 13 to 15, a deformation prevention unit 160 according to another embodiment of the present disclosure includes a base part 162 and a support frame 170.

The base part 162 is provided in contact with at least one of the upper side surface 41 and the lower side surface 71 of the case 20. Thus, deformation of the body of the case 20 can be prevented. The base part 162 may be a soft film or a plate. Since the base part 162 is the same as or similar to that of the previous embodiment of the present disclosure, a detailed description thereof is omitted.

The support frame 170 is provided on both sides of the length direction (D) of the base part 162 and may be formed in various shapes within the technical concept of having a recess portion in which an end of the case 20 is seated. As an example, the support frame 170 may include a support body 172 and an extension body 180. The support frame 170 has a seating groove 174 into which the base part 162 is inserted and fixed. When the base part 162 is shaped of a rectangular plate, the seating groove 174 provided in the support body 172 forms a rectangular groove.

The extension body 180 is connected to at least one of the upper and lower sides of the support body 172 and may be formed in various shapes within the technical concept of forming a recess portion on which an end of the case 20 is seated. As an example, the extension body 180 may include an upper body 182 and a lower body 190.

The upper body 182 extends upward from the support body 172 and may be formed in various shapes within the technical concept of forming a recess portion in which an end of the case 20 located on the upper side of the base part 162 is seated. The upper body 182 includes an upper guide recess 184 and an upper connection hole 186.

The upper guide recess 184 may be a recessed curved groove shaped to correspond to one end of the case 20. When an end of the case 20 is square, it is preferable that the upper guide recess 184 corresponding to the end be a rectangular groove.

One side of the upper connection hole 186 is connected to the outer side of the upper body 182 and the other side of the upper connection hole 186 is connected to the upper guide recess 184. The upper connection hole 186 may function as a passage through which the terminal portion 90 of the secondary battery 1 protrudes. The upper connection hole 186 may also serve as an exhaust passage for heat generated in the case 20.

The lower body 190 extends downward from the support body 172 and may be formed in various shapes within the technical concept of forming a recess portion in which an end of the case 20 located at the lower side of the base part 162 is seated. The lower body 190 includes a lower guide recess 192 and a lower connection hole 194.

The lower guide recess 192 may form a recessed groove shaped to correspond to an end of the case 20.

One side of the lower connection hole 194 is connected to the outside of the lower body 190 and the other side of the lower connection hole 194 is connected to the lower guide recess 192. Like the upper connection hole 186, the lower connection hole 194 may function as a passage through which the terminal portion 90 of the secondary battery 1 protrudes and may also serve as an exhaust passage for heat generated in the case 20.

The electrode assembly 10 of the present disclosure will be described in more detail.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiaA1-bXbO2-cDc(0.90≤a≤1.8, 0≤b≤0.5, 0≤c≤0.05); LiaMn2-bXbO4-cDc(0.90≤a≤1.8, 0≤b≤0.5, 0≤c≤0.05); LiaNi1-b-cCobXcO2-αDα(0.90≤a≤1.8, 0≤b≤0.5, 0≤c≤0.5, 0<α<2); LiaNi1-b-cMnbXcO2-αDα(0.90≤a≤1.8, 0≤b≤0.5, 0≤c≤0.5, 0<α<2); LiaNibCocL1dGeO2(0.90≤a≤1.8, 0≤b≤0.9, 0≤c≤0.5, 0≤d≤0.5, 0≤e≤0.1); LiaNiGbO2(0.90≤a≤1.8, 0.001≤b≤0.1); LiaCoGbO2(0.90≤a≤1.8, 0.001≤b≤0.1); LiaMn1-bGbO2(0.90≤a≤1.8, 0.001≤b≤0.1); LiaMn2GbO4(0.90≤a≤1.8, 0.001≤b≤0.1); LiaMn1-gGgPO4(0.90≤a≤1.8, 0≤g≤0.5); Li(3-f)Fe2(PO4)3(0≤f≤2); LiaFePO4(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 w t%, respectively, on the basis of 100 wt% of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

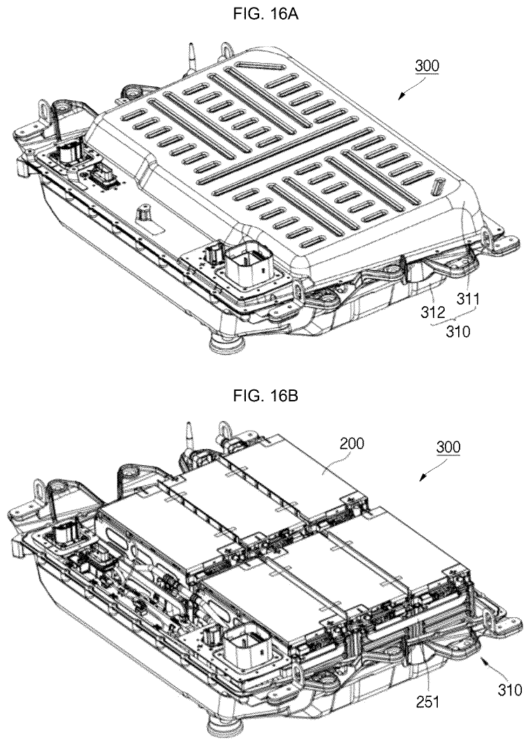

The batteries according to the above-described embodiments may be used to manufacture a battery pack. FIGS. 16A and 16B are perspective views showing a battery pack including the exemplary secondary battery 100 or 101 according to the present disclosure. Referring to FIGS. 16A and 16B, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

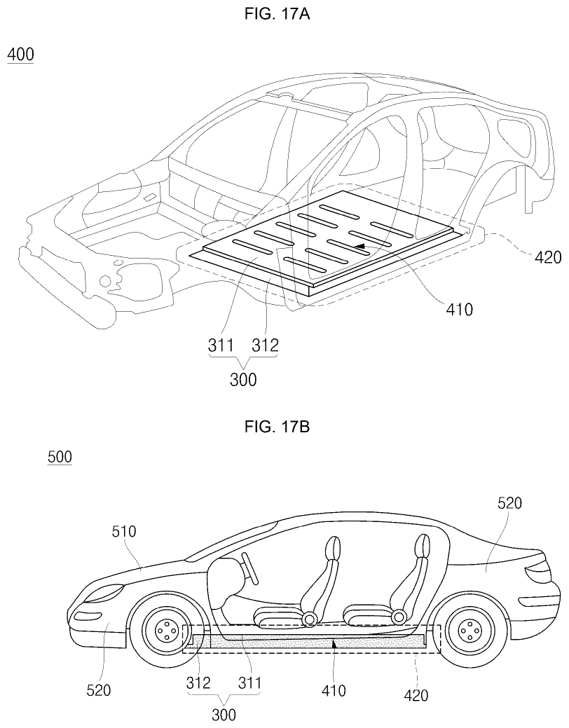

FIGS. 17A and 17B are, respectively, a perspective view and a side view showing vehicles 400 and 500 including the exemplary battery pack 300 according to the present disclosure.

In FIG. 17A, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 17B, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

Although a few embodiments of the present disclosure have been shown and described, it would be appreciated by those skilled in the art that various changes and modifications may be made in this embodiment without departing from the principles and spirit of the disclosure.

What is claimed is:

1. A secondary battery comprising:
an electrode assembly including a first electrode plate, a second electrode plate, and a separator;
a case for accommodating the electrode assembly; and
a deformation prevention unit in contact with an outer surface of the case and configured to prevent deformation of the case.

2. The secondary battery as claimed in claim 1, wherein the electrode assembly is in the form of a jelly roll or a stack.

3. The secondary battery as claimed in claim 1, wherein the case is formed from a soft film.

4. The secondary battery as claimed in claim 1, wherein the case is formed from an aluminum laminate sheet.

5. The secondary battery as claimed in claim 1, wherein the deformation prevention unit comprises:
a base part that contacts the outer surface of the case; and
a protrusion support part that is provided along an outer rim of the base part and supporting an outer rim of the case.

6. The secondary battery as claimed in claim 5, wherein the base part is formed from a film having insulating and flame-retardant properties.

7. The secondary battery as claimed in claim 6, wherein the film includes at least one of polyimide (PI), polyether ether ketone (PEEK), and polytetrafluoroethylene (PTFE).

8. The secondary battery as claimed in claim 5, wherein the base part includes at least one of mica, a polymer tape, and a pressure-sensitive tape.

9. The secondary battery as claimed in claim 5, wherein the deformation prevention unit further comprises an adhesive layer provided on an outer side of the base part and adhered to the case.

10. The secondary battery as claimed in claim 9, wherein the adhesive layer includes at least one of a thermosetting adhesive, a thermoplastic adhesive, a single-component epoxy adhesive, and a two-component epoxy adhesive.

11. The secondary battery as claimed in claim 5, wherein the base part comprises:
a filter member having insulating and flame-retardant properties; and
a base cover that accommodates the filter member, is connected to the protrusion support part, and supports the case.

12. The secondary battery as claimed in claim 11, wherein the deformation prevention unit further comprises an adhesive layer provided on an outer side of the base cover to adhere the base cover to the case.

13. The secondary battery as claimed in claim 5, wherein the protrusion support part is formed as a square frame and supports the outer rim of the base in both length and width directions.

14. The secondary battery as claimed in claim 5, wherein, a cross section of the protrusion support part is square or elliptical.

15. The secondary battery as claimed in claim 5, wherein the protrusion support part comprises:
an extension member that protrudes in at least one of a length and a width direction of the base part; and
a support member that extends upward and downward from the extension member and has a curved surface that corresponds to an outer shape of the case and supports the case.

16. The secondary battery as claimed in claim 5, wherein the case is provided on the upper and lower sides of the base part, and the protrusion support part protrudes from upper and lower sides of the base part to support the outer rim of the case on the upper and lower sides of the base part.

17. A secondary battery comprising:
an electrode assembly including a first electrode plate, a second electrode plate, and a separator;
a soft case for accommodating the electrode assembly; and
a deformation prevention unit provided in a shape that wraps around ends of the case and prevents deformation of the case.

18. The secondary battery as claimed in claim 17, wherein the deformation prevention unit comprises:
a base part in contact with at least one of upper and lower sides of the case; and
a support frame provided on the longitudinal sides of the base part and having a recess portion in which an end of the case is seated.

19. The secondary battery as claimed in claim 18, wherein the support frame comprises:
a support body having a seating channel into which the base part is inserted and seated; and
an extension body connected to at least one of upper and lower sides of the support body and forming the recess portion.

20. The secondary battery as claimed in claim 19, wherein the secondary battery includes a first case and a second case and the recess portion includes a first recess portion and a second recess portion, and
wherein the extension body comprises:
an upper body extending upwardly from the support body and forming the first recess portion in which an end of the first case located on the upper side of the base part is seated; and
a lower body extending downwardly from the support body and forming the second recess portion in which an end of the second case located on the lower side of the base part is seated.
